(19) United States
(12) Patent Application Publication
(10) Pub. No.: US 2023/0275655 A1
(43) Pub. Date: Aug. 31, 2023

(54) FLEXE NETWORK-BASED REROUTING METHOD AND APPARATUS, AND ELECTRONIC DEVICE AND READABLE STORAGE MEDIUM

(71) Applicant: ZTE Corporation, Shenzhen (CN)

(72) Inventor: Zhen LI, Shenzhen (CN)

(21) Appl. No.: 17/781,486

(22) PCT Filed: Nov. 24, 2020
(86) PCT No.: PCT/CN2020/131170

§ 371 Date: Jun. 1, 2022

(30) Foreign Application Priority Data
Dec. 3, 2019 (CN) 201911222917.5

(51) Int. Cl. H04B 10/038; H04L 45/28; H04L 12/46; H04Q 11/00

(52) U.S. Cl. CPC H04B 10/038; H04L 12/4641; H04L 45/28; H04Q 11/0062; H04Q 2011/0081

(57) ABSTRACT

A FlexE network-based rerouting method and apparatus, an electronic device, and a readable storage medium are disclosed. The FlexE network-based rerouting method includes: identifying a damaged first physical link by analysis in response to reception of an optical fiber breakage warning notification; determining an affected first data channel according to the first physical link; determining transmission capability of the first data channel; and configuring, according to the transmission capability, a desired timeslot of the first data channel to an idle timeslot capable of carrying the first data channel.

### CROSS REFERENCE TO RELATED APPLICATION

This application is a national stage filing under 35 U.S.C. § 371 of international application number PCT/CN2020/131170, filed Nov. 24, 2020, which claims priority to Chinese patent application No. 201911222917.5 filed Dec. 03, 2019. The contents of these applications are incorporated herein by reference in their entirety.

### TECHNICAL FIELD

Embodiments of the disclosure relate to the field of network communication, and in particular, to a FlexE network-based rerouting method and apparatus, an electronic device, and a readable storage medium.

### BACKGROUND

In the era of 5G, the FlexE (Flex Ethernet) technology has been introduced into the carrying network to meet the low latency, isolation, and flexibility of network slicing. FlexE is a solution that can meet the requirements of low latency, isolation, and flexibility. As the Ethernet network interface encountered a bottleneck after it developed to 400 G, the cost of hardware implementation increased nonlinearly. The conventional solution is LAG (Link Aggregation). LAG has obvious disadvantages: low efficiency (at a minimum of 60% to 70%); hash structure nonuniformity existing in an adopted hash algorithm; failure of the hash algorithm for a single heavy-traffic business; direct correlation to the business layer (high coupling degree); and incapability of smoothly switching without loss.

Technical Idea of FlexE: The original purpose of putting forward FlexE is to make the interface rate no longer be a fixed rate (such as 100 G or 400 G PHY), decouple the business layer from the physical layer and enable the interface rate of the business layer to be flexible (such as n*100 G or n*400 G). The FlexE standard was established at the OIF (Optical Internetworking Forum). The OIF established a FlexE Shim layer (similar to an ODUCn of a B100G OTN) supporting time division multiplexing, which can carry various Ethernet businesses (FlexE clients) defined by IEEE, and FlexE Shim carries out transmission through multiple bonded PHYs.

FlexE Crossover Technique: The timeslot crossover technique of the FlexE Shim layer can provide hundred-ns-level ultralow delay forwarding performance when employed, which is similar to the delay determination performance of a circuit.

Totally 3 layers of paths are abstracted for FlexE end-to-end:

FlexE Group Link: There are only PE nodes, and the endpoints A and Z are FlexE group objects, respectively. One FlexE group may be bonded with one or more Ethernet ports, and the port rate may be 50 G, 100 G, or 400 G, typically 100 G.

FlexE Channel: Single point objects corresponding to a FlexE channel are FlexE clients, which are divided into PE and P nodes. The FlexE clients of the PE nodes are terminal, while the FlexE clients of the P nodes are non-terminal. Moreover, the two FlexE clients of the P nodes form a timeslot crossover. Its service layer is one or more FlexE Group links. The FlexE channel can form end-to-end protection, that is, the FlexE clients of the PE node may be configured with a protection group, and protection switching may be triggered by OAM detection and warning.

FlexE Ethernet Channel: On the basis of a FlexE channel, a FlexE Ethernet tunnel creates VEI 3-layer virtual interfaces and virtual subinterfaces at the PE nodes at both ends, and the virtual interfaces or the virtual subinterfaces are configured with an IP and a Vlan, so as to carry a tunnel.

At present, in a FlexE network, the conventional method for automatic recovery of network failure is to carry out rerouting in the tunnel layer, which is a business layer above the Ethernet channel layer. In this method, routing recalculation, forwarding label adjustment and other acts are performed directly in the tunnel layer, so as to achieve the objective of reconfiguring the path. The advantage of this method is that only the forwarding label is generally adjusted on a device, and the interaction with the device is less and lighter. In particular, the 5G SR tunnel only modifies the data of the label stack of the head node. However, the disadvantage of this method is also obvious. That is, if breakage of an optical fiber affects a large number of tunnels, it will trigger a great deal of tunnel rerouting.

### SUMMARY

In view of this, embodiments of the disclosure provide a FlexE network-based rerouting method and apparatus, an electronic device, and a readable storage medium.

An embodiment of the disclosure provides a FlexE network-based rerouting method, including: identifying a damaged first physical link by analysis in response to reception of an optical fiber breakage warning notification; determining an affected first data channel according to the first physical link; determining transmission capability of the first data channel; and configuring, according to the transmission capability, a desired timeslot of the first data channel to an idle timeslot capable of carrying the first data channel.

An embodiment of the disclosure provides a FlexE network-based rerouting apparatus, including: an analysis module, configured to identify a damaged first physical link by analysis in response to reception of an optical fiber breakage warning notification; a first determination module, configured to determine an affected first data channel according to the first physical link; a second determination module, configured to determine transmission capability of the first data channel; and a switching module, configured to configure, according to the transmission capability, a desired timeslot of the first data channel to an idle timeslot capable of carrying the first data channel.

An embodiment of the disclosure further provides an electronic device, including: at least one processor; and a memory in communication with the at least one processor. The memory stores instructions which, when executed by the at least one processor, cause the at least one processor to carry out the aforementioned FlexE network-based rerouting method.

An embodiment of the disclosure further provides a computer-readable storage medium storing a computer program which, when executed by the processor, causes the processor to carry out the aforementioned FlexE network-based rerouting method.

The description above is merely the summary of the technical schemes of the disclosure, and in order to more clearly illustrate the technical means of the disclosure so as to implement the technical means according to the content of the specification, and in order to make the above and other objectives, features and advantages of the disclosure more apparent, detailed description of the disclosure will be provided hereinafter.

### BRIEF DESCRIPTION OF DRAWINGS

Exemplary descriptions will be made for one or more embodiments with reference to the figures in the corresponding accompanying drawings without constituting a limitation on the embodiments. Elements with the same reference numerals in the accompanying drawings are represented as similar elements, and unless stated otherwise, the figures in the accompanying drawings do not constitute a scale limitation.

FIG. 1 is a flowchart of a FlexE network-based rerouting method according to a first embodiment of the disclosure;

FIGS. 2a and 2b are schematic diagrams of exemplary networking in the FlexE network-based rerouting method according to the first embodiment of the disclosure;

FIG. 3 is a flowchart of a process of searching for an idle timeslot capable of carrying a first data channel and switching timeslot configuration in the FlexE network-based rerouting method according to a second embodiment of the disclosure;

FIG. 4 is a flowchart of a revertive switching process in the FlexE network-based rerouting method according to a third embodiment of the disclosure;

FIG. 5 is a schematic diagram of a FlexE network-based rerouting apparatus according to a fourth embodiment of the disclosure; and

FIG. 6 is a schematic structural diagram of an electronic device according to a fifth embodiment of the disclosure.

### DETAILED DESCRIPTION

In order to make the objectives, technical schemes and advantages of the embodiments of the disclosure clearer, each embodiment of the disclosure will be set forth in detail hereinafter with reference to the accompanying drawings. However, those having ordinary skills in the art can understand that many technical details are put forward in each embodiment of the disclosure for readers to better understand the present application. However, even without these technical details and various changes and modifications based on the following embodiments, the technical schemes for which protection are sought by the present application can still be implemented. The division of the following embodiments is intended to facilitate description, and should not constitute any limitation on specific implementations of the disclosure. All the embodiments may be combined with and refer to one another under the premise of no contradiction.

A first embodiment of the disclosure relates to a FlexE network-based rerouting method. This embodiment may be applied to an electronic device. The electronic device may be a device with a FlexE port mode turned on, such as an access layer device, a convergence layer device and the like, which will not be listed here.

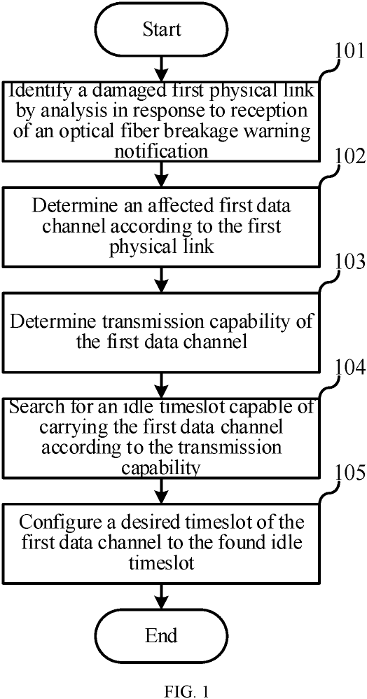

As shown in FIG. 1, the flow of the FlexE network-based rerouting method in this embodiment includes steps S101 to S105.

At S101, a damaged first physical link is identified by analysis in response to reception of an optical fiber breakage warning notification.

In an embodiment, the optical fiber breakage warning notification is configured to give a warning about the occurrence of physical link breakage, which may be an LOS (Loss of Signal) warning. Then, according to a warning source of the optical fiber breakage warning notification, an affected physical port is determined; and according to the physical port, a damaged first physical link is determined. The warning source (i.e., the faulty physical port) is indicated in the warning, and through the physical port at both ends of a physical optical link, the affected physical optical link (such as an optical fiber) may be identified by analysis.

At S102, an affected first data channel is determined according to the first physical link.

In an embodiment, an affected group may also be determined according to the optical fiber breakage warning notification. The group records the information of the involved physical optical link. Through the first physical link determined in S101, an affected group path may be identified by analysis. Then, through the affected group path and the affected physical optical link, an affected data channel (also referred to as channel) may be obtained by calculation. In practice, there may be multiple channels affected, that is, multiple first data channels may be determined.

At S103, transmission capability of the first data channel is determined.

It should be noted that as the OIF established a FlexeSim layer supporting time division multiplexing, the timeslot in this embodiment, as a basic resource type, is a bandwidth resource in kbps, and 1 timeslot may be defined as 5 Gbps or 1 Gbps. Therefore, the transmission capacity of an optical fiber may be determined by determining a timeslot correspondingly bonded to the optical fiber. In an embodiment, the information of data of the bonded optical link is stored in the channel, that is, a timeslot correspondingly bonded to each optical fiber is stored in the channel. That is, the transmission capacity of the first data channel may be determined by the information stored in the channel.

It should be noted that one optical fiber may be bonded to multiple timeslots, so the total number of the multiple timeslots may be regarded as the transmission capacity of the first data channel.

At S104, an idle timeslot capable of carrying the first data channel is searched for according to the transmission capability.

In an embodiment, whether a timeslot is occupied or not may be determined according to whether the timeslot is bonded to a physical link. If there is an unoccupied timeslot in the channel, then whether the size of the timeslot is greater than or equal to the transmission capacity determined in S103 is judged. If a determination is made that the transmission capacity of the first data channel is 50 G and a 100 G idle timeslot is then found from a second physical optical link in the same group as the damaged first physical optical link, then a determination is made that an idle timeslot which is sufficient to carry the first data channel is found.

More specifically, during searching, an idle timeslot capable of carrying the first data channel is searched for from another physical link in the same group as the first physical link. Because the groups at both ends of the physical links in the same group are the same and the usage of each timeslot is recorded in the groups, the groups at both ends of the damaged first physical link may be found according to the damaged first physical link, and timeslots not in use (i.e., idle timeslots) are searched for from the timeslot records of the groups. Moreover, because the timeslot records in the groups are recorded in ports, whether an idle timeslot belongs to the damaged first physical link may be determined through the port where the timeslot is located, and then, an idle timeslot not on the first physical link (i.e., an idle timeslot on another physical link in the same group as the first physical link) is found.

It should be noted that after the available idle timeslot is found, continue to judge whether the timeslot can carry the transmission capacity of the first data channel. In practice, when an idle timeslot is not enough for carrying, multiple idle timeslots may also be searched for, which belong to the same physical link. Moreover, if the sum of multiple idle timeslots is greater than or equal to the transmission capacity of the first data channel, a determination may also be made that the idle timeslots capable of carrying the first data channel are found.

At S105, the desired timeslot of the first data channel is configured to the found idle timeslot.

In an embodiment, the first data channel is subjected to timeslot adjustment, and the connection positions at both ends of the first data channel are configured as the idle timeslot found in S104. That is, clients at both ends of the first data channel are configured from the original physical link to the physical link where the idle timeslot is located.

In practice, in S104 and S105 above, the desired timeslot of the first data channel is configured to the idle timeslot capable of carrying the first data channel according to the transmission capability. In practice, a standby idle timeslot may be preset, so that the standby idle timeslot may be used if a physical link is damaged.

The rerouting method based on S101 to S105 above may be verified by networking. The basic physical networking process is as follows:

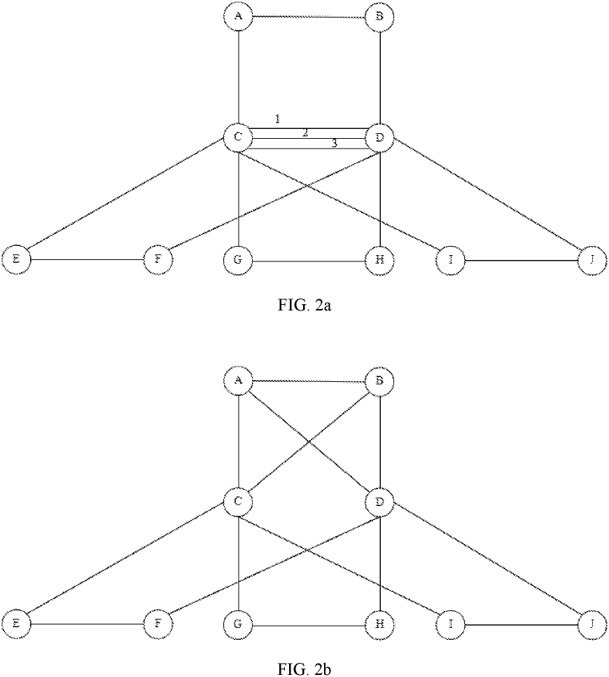

1. Physical networking is carried out according to FIG. 2a in which A, B, C, D, E, F, G, H, I and J are physical network elements and connecting lines between the network elements are physical optical fibers.

2. Three access loops (CDEF, CDGH and CDIJ) and a convergence loop (ABCD) are formed respectively.

3. There are three optical fibers (optical fiber No. 1, optical fiber No. 2 and optical fiber No. 3, respectively) between the network element C and the network element D, 50 G each in bandwidth. The FlexE mode is turned on at these three pairs of optical ports of the network element C and the network element D, and the three optical ports on each side are bonded as a FlexE group, respectively, forming a FlexE Group link.

4. There is a 100 G optical fiber between the network element A and the network element B, and the FlexE mode is turned on, forming a FlexE Group link.

5. There is a 100 G optical fiber between the network element A and the network element C, and the FlexE mode is turned on, forming a FlexE Group link.

6. There is a 100 G optical fiber between the network element B and the network element D, and the FlexE mode is turned on, forming a FlexE Group link.

7. The rest of the optical fibers are optical fibers for the access loops, which are 10G in bandwidth, and ordinary Ethernet channels may be directly formed without turning on the FlexE mode.

The verification process is implemented according to steps S1 to S17 in sequence.

At S1, a FlexE Channel with a bandwidth of 15 G is configured between A and D, the path is ACD in which the CD section is based on the optical fiber No. 1, rerouting is supported, and revertive switching is not allowed.

At S2, a FlexE Ethernet channel with a bandwidth of 15 G is configured between A and D, and the service layer is a FlexE channel established in S1.

At S3, a FlexE Channel with a bandwidth of 15 G is configured between B and C, the path is BDC in which the DC section is based on the optical fiber No. 1, rerouting is supported, and revertive switching is not allowed.

At S4, a FlexE Ethernet channel with a bandwidth of 15 G is configured between B and C, and the service layer is a FlexE channel established in S3.

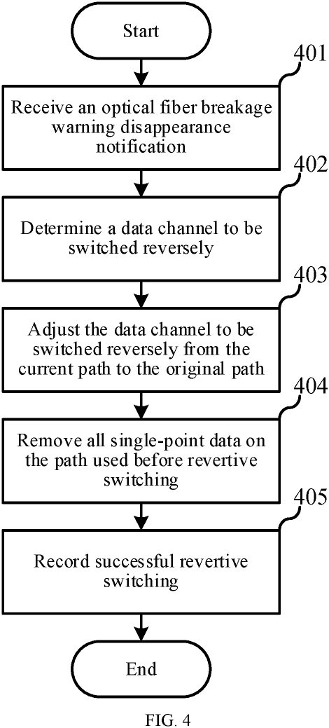

At S5, after the above configuration, Ethernet networking is shown in FIG. 4, and the SR tunnel is configured as follows based on this Ethernet network.

At S6, ten SR tunnels are created between E and B, 100 M each in bandwidth, and the path is ECB in which the EC section is an ordinary Ethernet channel and the CB section is a FlexE Ethernet channel.

At S7, ten SR tunnels are created between F and A, 100 M each in bandwidth, and the path is FDA in which the FD section is an ordinary Ethernet channel and the DA section is a FlexE Ethernet channel.

At S8, ten SR tunnels are created between G and B, 100 M each in bandwidth, and the path is GCB in which the GC section is an ordinary Ethernet channel and the CB section is a FlexE Ethernet channel.

At S9, ten SR tunnels are created between H and A, 100 M each in bandwidth, and the path is HDA in which the HD section is an ordinary Ethernet channel and the DA section is a FlexE Ethernet channel.

At S10, ten SR tunnels are created between I and B, 100 M each in bandwidth, and the path is ICB in which the IC section is an ordinary Ethernet channel and the CB section is a FlexE Ethernet channel.

At S11, ten SR tunnels are created between J and A, 100 M each in bandwidth, and the path is JDA in which the JD section is an ordinary Ethernet channel and the DA section is a FlexE Ethernet channel.

At S12, as shown in FIG. 2b, the optical fiber No. 1 between C and D is unplugged to artificially create an optical fiber breakage warning.

At S13, a rerouting module receives the optical fiber breakage warning, and identifies two affected FlexE channels (ACD and BDC) by analysis.

At S14, rerouting begins for ACD and BDC, it is identified by analysis that the optical fiber No. 1 is broken on the FlexE Group link of the fiber-broken CD section, and there remain 100 G idle timeslots on the remaining optical fibers No. 2 and No. 3, which are enough to carry two 15 G FlexE channels.

At S15, the CD section of ACD is subjected to FlexE timeslot adjustment, so that the FlexE clients at both ends of CD is adjusted from the optical fiber No. 1 on the original FlexE Group link to the optical fiber No. 2.

At S16, the DC section of BDC is subjected to FlexE timeslot adjustment, so that the FlexE clients at both ends of DC is adjusted from the optical fiber No. 1 on the original FlexE Group link to the optical fiber No. 2.

At S17, the rerouting is completed.

It can be seen from the aforementioned rerouting process that as the optical fiber of the key path CD is broken, the network needs to be recovered automatically, and on the condition that sixty SR tunnel services are established among three access loops and a convergence loop, rerouting will be triggered simultaneously for the sixty SR tunnel services if rerouting is conventionally performed on the SR tunnel layer, leading to a large amount of device adjustments. By contrast, if rerouting is performed on the lower FlexE Channel layer, it only needs to be performed on two FlexE channels, so there will be relatively less device adjustments. In particular, on the condition that there are sufficient idle timeslot resources on FlexE Group links, such adjustments are very slight, so rerouting can be completed in a short time.

To sum up, in this embodiment, after an optical fiber breakage warning notification is received, a damaged physical connection is determined first, an affected data channel is then determined, other available timeslots are searched for the affected data channel, and thereby, all business data on the affected data channel are transferred to the found timeslots, achieving rapid rerouting. Moreover, as the number of data channels affected by optical fiber breakage is small, the number involved in rerouting is small, and contents to be adjusted are reduced, thus speeding up rerouting caused by optical fiber breakage and decreasing the perception of users.

A second embodiment of the disclosure relates to a FlexE network-based rerouting method. This embodiment is a further improvement on the basis of the first embodiment. The main improvement is as follows: In the first embodiment, idle time slots are searched for in another physical link in the same group as a damaged physical link, while in this embodiment, besides searching in the physical links in the same group, searching may also be extended to another physical link on an available path, expanding the searching range of idle time slots, facilitating to find an idle time slot for carrying, and increasing the success rate of rerouting.

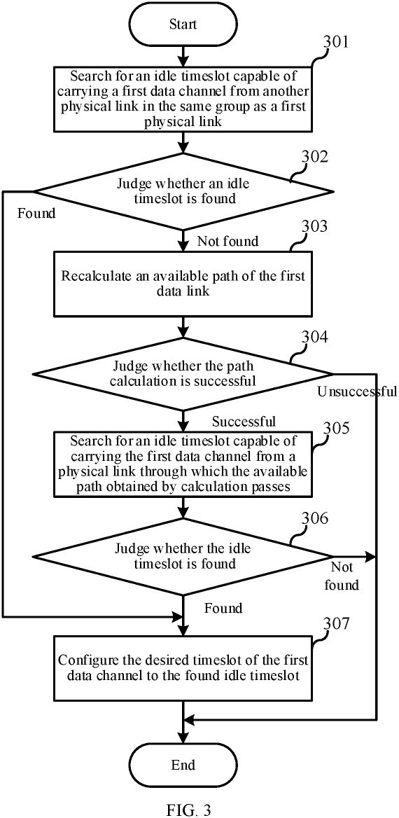

As shown in FIG. 3, the flowchart of a process of searching for an idle timeslot capable of carrying a first data channel and switching timeslot configuration in the FlexE network-based rerouting method in this embodiment includes steps S301 to S307.

At S301, an idle timeslot capable of carrying a first data channel is searched for from another physical link in the same group as a first physical link.

In an embodiment, S301 in this embodiment is similar to S104 in the first embodiment, and therefore will not be repeated here.

At S302, whether an idle timeslot capable of carrying the first data channel is found is judged; if so, S307 is executed; and if not, S303 is executed.

In an embodiment, in this step, whether an idle timeslot capable of carrying the first data channel is found is judged after searching in S301; if so, S307 is directly executed; and if not, S303 is continued.

At S303, an available path of the first data channel is recalculated.

In an embodiment, the available path of the first data channel is determined by a path algorithm. Taking FIG. 2b as an example, after the physical link CD is damaged, available paths between C and D include CAD and CBD.

At S304, whether path calculation is successful is judged; if so, then S305 is executed; and if not, the FlexE network-based rerouting method in this embodiment is ended.

In an embodiment, as long as one available path is obtained by calculation, the path calculation may be considered successful, and correspondingly, if no available path is obtained by calculation, then the path calculation may be considered unsuccessful.

At S305, an idle timeslot capable of carrying the first data channel is searched for from a physical link through which the available path obtained by calculation passes.

In an embodiment, taking FIG. 2b as an example, the available paths include CAD and CBD, so an idle timeslot capable of carrying the first data channel may be searched for from the physical link through which CAD and CBD pass.

At S306, whether an idle timeslot capable of carrying the first data channel is found is judged; if so, then S307 is executed; and if not, the FlexE network-based rerouting method in this embodiment is ended.

At S307, the desired timeslot of the first data channel is configured to the found idle timeslot.

In an embodiment, in this step, after an idle timeslot capable of carrying the transmission capability of the first data channel is successfully found, the desired timeslot of the first data channel is configured to the found idle timeslot. The specific configuration process includes configuring clients at both ends of the first data channel from the original physical link to the physical link where the idle timeslot found in S305 is located.

It can be seen that in this embodiment, because an available timeslot can be searched for not only from another physical link in the same group as the damaged physical link but also from the available path obtained by calculation, the range of searching is expanded, a suitable idle timeslot can be more easily found, and the success rate of the FlexE network-based rerouting method in this embodiment is increased.

A third embodiment of the disclosure relates to a FlexE network-based rerouting method. The third embodiment is a further improvement on the basis of the second embodiment. The main improvement is as follows: In the third embodiment of the disclosure, a revertive switching mechanism is provided in order to change the data channel of a path, so that the original path may be resumed after a physical optical link has been repaired, further reducing the influence on data channels.

In an embodiment, after the desired timeslot of the first data channel is configured to an idle timeslot if the idle timeslot capable of carrying the first data channel is found in the physical link through which the found available path passes, the FlexE network-based rerouting method further includes: switching reversely the first data channel in response to reception of an optical fiber breakage warning disappearance notification.

FIG. 4 is taken as an example to illustrate the revertive switching process after the reception of an optical fiber breakage warning disappearance notification. The revertive switching process includes steps S401 to S405.

At S401, an optical fiber breakage warning disappearance notification is received.

In an embodiment, this optical fiber breakage warning disappearance notification is triggered after the broken optical fiber has been repaired.

At S402, a data channel to be switched reversely is determined.

In an embodiment, for a data channel requiring revertive switching, the original path is recorded after a path change, so that whether this data channel is required to be switched reversely may be determined according to whether the original path is recorded.

It should be noted that if the desired timeslot of the data channel is configured to a timeslot of another optical fiber in the same group as the damaged optical fiber, then revertive switching is not required because the path is not changed.

At S403, the data channel to be switched reversely is adjusted from the current path to the original path.

In an embodiment, the data channel to be switched reversely may be adjusted to the original timeslot of the original path.

At S404, all single-point data on the path used before revertive switching is removed.

At S405, successful revertive switching is recorded.

Taking FIG. 2b as an example, after the optical fiber between C and D is damaged, the original path BDC cannot transmit data, and then the data channel is switched to a new path BAC according to path calculation. Afterwards, an optical fiber breakage warning disappearance notification is received, and a determination is made that the optical fiber between C and D has been repaired, and therefore the data channel may be switched from the new path BAC reversely to the original path BDC. After revertive switching, all single-point data on BAC are removed, and successful revertive switching is recorded.

It can be seen that as this embodiment is added with the revertive switching mechanism, after a broken optical fiber has been repaired, the original data channel can resume the original path as much as possible, reducing the influence of optical fiber breakage on data channels.

Dividing the above various methods into the steps is merely to make description clear, and during implementation, the steps may be combined into one step, or certain steps may be divided into a plurality of steps, both of which shall fall within the protection scope of the present patent as long as the same logic relation is contained. Addition of inessential modifications or introduction of inessential designs into the algorithm or the flow which does not change the core designs of the algorithm and the flow shall fall within the protection scope of the present patent application.

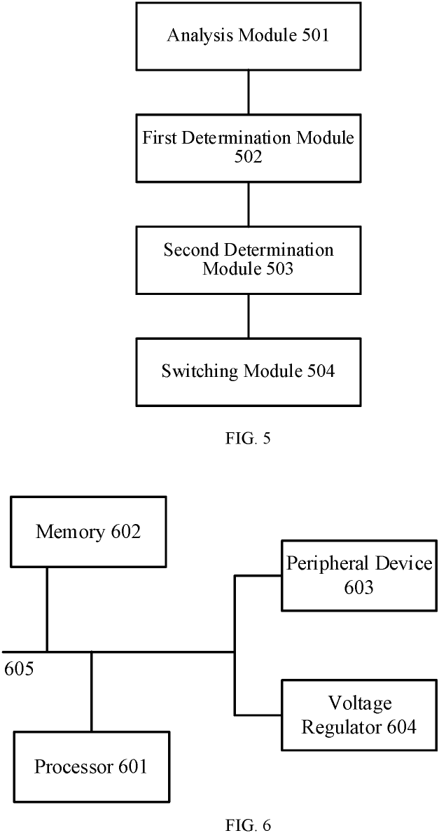

A fourth embodiment of the disclosure relates to a FlexE network-based rerouting apparatus. As shown in FIG. 5, the FlexE network-based rerouting apparatus in this embodiment includes: an analysis module 501, a first determination module 502, a second determination module 503 and a switching module 504.

The analysis module 501 is configured to identify a damaged first physical link by analysis in response to reception of an optical fiber breakage warning notification.

The first determination module 502 is configured to determine an affected first data channel according to the first physical link.

The second determination module 503 is configured to determine transmission capability of the first data channel.

The switching module 504 is configured to configure, according to the transmission capability, a desired timeslot of the first data channel to an idle timeslot capable of carrying the first data channel.

It can be seen that in this embodiment, after an optical fiber breakage warning notification is received, a damaged physical connection is determined first, an affected data channel is then determined, other available timeslots are searched for the affected data channel, and thereby, all business data on the affected data channel are transferred to the found timeslots, achieving rapid rerouting. Moreover, as the number of data channels affected by optical fiber breakage is small, the number involved in rerouting is small, and contents to be adjusted are reduced, thus speeding up rerouting caused by optical fiber breakage and decreasing the perception of users.

The fifth embodiment of the disclosure relates to an electronic device, as shown in FIG. 6, the electronic device includes: at least one processor 601; and a memory 602 in communication with the at least one processor 601. The memory 602 stores an instruction that is executable by the at least one processor 601, and when executed by the at least one processor 601, the instruction enables the at least one processor 601 to execute the FlexE network-based rerouting method in the aforementioned first or second embodiment.

The memory 602 and the processor 601 are connected in a bus manner. A bus 605 may include any number of interconnected buses 605 and bridges. The bus 605 connects various circuits of the one or more processors 601 and the memory 602 together. The bus 605 may also connect various other circuits such as a peripheral device 603, a voltage regulator 604, a power management circuit and the like, which are well-known in the art and therefore will not be further described herein. A bus interface provides an interface between the bus 605 and a transceiver. The transceiver may be one component or multiple components (such as multiple receivers and transmitters), providing a unit for communicating with various other apparatuses on a transmission medium. Data processed by the processor 601 are transmitted on a wireless medium through an antenna. Further, the antenna also receives data and transmits the data to the processor 601.

The processor 601 is configured to manage the bus 605 and conventional processing, and may also provide various functions, including timing, peripheral interfaces, voltage regulation, power management and other control functions. The memory 602 may be configured to store data used by the processor 601 when performing operations.

A sixth embodiment of the disclosure relates to a computer-readable storage medium, which stores a computer program. When executed by the processor, the computer program implements the aforementioned method embodiments.

In this embodiment, after an optical fiber breakage warning notification is received, a damaged physical connection is determined first, an affected data channel is then determined, other available timeslots are searched for the affected data channel, and thereby, all business data on the affected data channel are transferred to the found timeslots, achieving rapid rerouting. Moreover, as the number of data channels affected by optical fiber breakage is small, the number involved in rerouting is small, and contents to be adjusted are reduced, thus speeding up rerouting caused by optical fiber breakage.

It can be understood by those having ordinary skills in the art that all or some of the steps in the methods and the functional modules/units in the system and device disclosed above may be implemented as software, firmware, hardware, and their appropriate combinations. In a hardware implementation, the division of the functional modules/units mentioned in the above description does not necessarily correspond to the division of physical components. For example, a physical component may have multiple functions, or a function or a step may be executed by a plurality of physical components in cooperation. Some or all of the physical components may be implemented as software executed by a processor (such as a central processing unit, a digital signal processor or a microprocessor), hardware or an integrated circuit (such as an application-specific integrated circuit). Such software may be distributed on a computer-readable medium, which may include a computer storage medium (or nontransitory medium) and a communication medium (or transitory medium). As well-known to those having ordinary skills in the art, the term “computer storage medium” include volatile and nonvolatile, removable and non-removable media implemented in any method or technology for storing information (such as a computer-readable instruction, a data structure, a program module, or other data). The computer storage medium includes but are not limited to RAM, ROM, EEPROM, flash memory or other memory technologies, CD-ROM, digital versatile disk (DVD) or other optical disk storage, magnetic cassette, magnetic tape, magnetic disk storage or other magnetic storage device or any other medium that may be used to store desired information and may be accessed by a computer. Further, it is well-known to those having ordinary skills in the art that the communication medium typically contains a computer-readable instruction, a data structure, a program module, or other data in a modulated data signal such as a carrier or other transmission mechanism, and may include any information delivery medium.

Those having ordinary skills in the art should understand that the above-mentioned embodiments are some embodiments of the disclosure, and in practical application, various changes may be made to the embodiments in terms of forms and details without departing from the scope of the disclosure.

1. A FlexE network-based rerouting method, comprising:
identifying a damaged first physical link by analysis in response to reception of an optical fiber breakage warning notification;
determining an affected first data channel according to the first physical link;
determining transmission capability of the first data channel; and
configuring, according to the transmission capability, a desired timeslot of the first data channel to an idle timeslot capable of carrying the first data channel.

2. The FlexE network-based rerouting method of claim 1, further comprising:
searching for the idle timeslot capable of carrying the first data channel, wherein the searching for the idle timeslot capable of carrying the first data channel comprises:
searching for the idle timeslot from a physical link other than the first physical link in a same group as the first physical link.

3. The FlexE network-based rerouting method of claim 2, wherein the searching for the idle timeslot capable of carrying the first data channel further comprises:
recalculating an available path for the first data channel in response to the idle timeslot being not found in the other physical link in the same group as the first physical link; and
searching for the idle timeslot capable of carrying the first data channel from a physical link through which the available path passes.

4. The FlexE network-based rerouting method of claim 3, wherein in response to the idle timeslot capable of carrying the first data channel being found in the physical link through which the available path passes, after configuring the desired timeslot of the first data channel to the idle timeslot, the method further comprises:
switching the first data channel reversely to an original timeslot in response to reception of an optical fiber breakage warning disappearance notification.

5. The FlexE network-based rerouting method of claim 1, wherein the identifying a damaged first physical link by analysis comprises:
determining an affected physical port according to a warning source of the optical fiber breakage warning notification; and
determining the damaged first physical link according to the physical port.

6. The FlexE network-based rerouting method of claim 1, wherein the determining transmission capability of the first data channel comprises:
determining timeslots corresponding to the first data channel, and taking all the timeslots corresponding to the first data channel as the transmission capability of the first data channel.

7. The FlexE network-based rerouting method of claim 1, wherein the idle timeslot capable of carrying the first data channel comprises a plurality of idle timeslots, and the plurality of idle timeslots belong to a same physical link.

8. (canceled)

9. An electronic device, comprising:
at least one processor; and
a memory in communication with the at least one processor; wherein
the memory stores instructions which, when executed by the at least one processor, cause the at least one processor to carry out a FlexE network-based rerouting methodcomprising:
identifying a damaged first physical link by analysis in response to reception of an optical fiber breakage warning notification;
determining an affected first data channel according to the first physical link;
determining transmission capability of the first data channel; and
configuring, according to the transmission capability, a desired timeslot of the first data channel to an idle timeslot capable of carrying the first data channel.

10. A non-transitory computer-readable storage medium storing a computer program which, when executed by a processor, causes the processor to carry out a FlexE network-based rerouting method comprising:
identifying a damaged first physical link by analysis in response to reception of an optical fiber breakage warning notification;
determining an affected first data channel according to the first physical link;
determining transmission capability of the first data channel; and
configuring, according to the transmission capability, a desired timeslot of the first data channel to an idle timeslot capable of carrying the first data channel.

11. The electronic device of claim 9, wherein the method further comprises:
searching for the idle timeslot capable of carrying the first data channel, wherein the searching for the idle timeslot capable of carrying the first data channel comprises:
searching for the idle timeslot from a physical link other than the first physical link in a same group as the first physical link.

12. The electronic device of claim 11, wherein the searching for the idle timeslot capable of carrying the first data channel further comprises:
recalculating an available path for the first data channel in response to the idle timeslot being not found in the other physical link in the same group as the first physical link; and
searching for the idle timeslot capable of carrying the first data channel from a physical link through which the available path passes.

13. The electronic device of claim 12, wherein in response to the idle timeslot capable of carrying the first data channel being found in the physical link through which the available path passes, after configuring the desired timeslot of the first data channel to the idle timeslot, the method further comprises:
switching the first data channel reversely to an original timeslot in response to reception of an optical fiber breakage warning disappearance notification.

14. The electronic device of claim 9, wherein the identifying a damaged first physical link by analysis comprises:
determining an affected physical port according to a warning source of the optical fiber breakage warning notification; and
determining the damaged first physical link according to the physical port.

15. The electronic device of claim 9, wherein the determining transmission capability of the first data channel comprises:
determining timeslots corresponding to the first data channel, and
taking all the timeslots corresponding to the first data channel as the transmission capability of the first data channel.

16. The electronic device of claim 9, wherein the idle timeslot capable of carrying the first data channel comprises a plurality of idle timeslots, and the plurality of idle timeslots belong to a same physical link.

17. The non-transitory computer-readable storage medium of claim 10, wherein the method further comprises:
searching for the idle timeslot capable of carrying the first data channel, wherein the searching for the idle timeslot capable of carrying the first data channel comprises:
searching for the idle timeslot from a physical link other than the first physical link in a same group as the first physical link.

18. The non-transitory computer-readable storage medium of claim 17, wherein the searching for the idle timeslot capable of carrying the first data channel further comprises:
recalculating an available path for the first data channel in response to the idle timeslot being not found in the other physical link in the same group as the first physical link; and
searching for the idle timeslot capable of carrying the first data channel from a physical link through which the available path passes.

19. The non-transitory computer-readable storage medium of claim 18, wherein in response to the idle timeslot capable of carrying the first data channel being found in the physical link through which the available path passes, after configuring the desired timeslot of the first data channel to the idle timeslot, the method further comprises:
switching the first data channel reversely to an original timeslot in response to reception of an optical fiber breakage warning disappearance notification.

20. The non-transitory computer-readable storage medium of claim 10, wherein the identifying a damaged first physical link by analysis comprises:
determining an affected physical port according to a warning source of the optical fiber breakage warning notification; and
determining the damaged first physical link according to the physical port.

21. The non-transitory computer-readable storage medium of claim 10, wherein the determining transmission capability of the first data channel comprises:
determining timeslots corresponding to the first data channel, and
taking all the timeslots corresponding to the first data channel as the transmission capability of the first data channel.
